(19) United States
(12) Patent Application Publication
(10) Pub. No.: US 2023/0405600 A1
(43) Pub. Date: Dec. 21, 2023

(54) AN AERO ACOUSTIC PROCESSING APPARATUS AND PROCESS FOR PROCESSING WASTE

(71) Applicants: Vortex Industrial Solutions LTD, St. Peter Port (GB); BARNARD, Keenan-Jay, Pretoria (ZA)

(72) Inventor: Colin Bruce RAWSON, Cybercity Ebene (MU)

(21) Appl. No.: 18/033,369

(22) PCT Filed: Oct. 29, 2021
(86) PCT No.: PCT/ZA2021/050063

§ 371 Date: Apr. 24, 2023

(30) Foreign Application Priority Data
Oct. 29, 2020 (ZA) 2020/06742

(51) Int. Cl. B02C 19/06; B02C 19/18; B02C 19/00; F04D 29/22; F04D 7/02

(52) U.S. Cl. CPC B02C 19/06; B02C 19/18; F04D 7/02; F04D 29/2288; B02C 19/0056

(57) ABSTRACT

An aero acoustic processing apparatus includes an aero acoustic processing machine (10) having a cyclone chamber (12) having an inlet (14) for receiving waste to be processed and an inlet (16) for an entraining gas in the form of air. A rotational drive apparatus in the form of an electric motor (18) is coupled to a shaft (20) to which an impeller (22) is coupled rotates the impeller (22) within an impeller housing (24) to draw the air and the waste material to be processed into the cyclone chamber (12) and through an axial inlet system (26) into the impeller (22) and impeller housing (24) and to expel the processed material through the impeller housing (24) radially through a transverse outlet.

### TECHNICAL FIELD

The invention relates to an aero acoustic processing apparatus and process for processing waste, including delamination and separation thereof, the waste typically makes up an end-of-life or waste product for the purpose of recycling the component parts.

### BACKGROUND TO THE INVENTION

WO 98/35756 discloses that it was found that a cyclone created in a stream of air passing through a conduit, preferably of circular cross-section, the centripetal forces created by the motion of the air stream pull any particulate material entrained in the air stream away from the walls of the conduit and towards its central region. If a wide range of sonic frequencies are created within the conduit, a pattern of powerful vortices are created in the air stream. Energies are released by conversion of the potential energy to kinetic energy due to the stresses created within the cyclone which causes a minute explosion. The vortices of the cyclone take the form of implosions which are capable of breaking the material up further into smaller particles.

It was also found that the vortices created in the cyclonic air stream carry further harmonic frequencies generated by the specially designed apparatus, this sets up a pulse from the standing wave configuration within the system, and this causes pockets of air within the standing wave to achieve a velocity beyond the sonic range. This can be tuned for a particular type of material which enhances the ability of the vortices created to break up very hard and soft materials such as stone and to dry materials.

Delamination of Waste Materials

Extensive dumping of used and superseded materials and products by the world's rapidly expanding population, and the affluence of market economies driven by persistent growth in the production of commodities, has led to a massive increase in the volume of waste and its inevitable impact on the environment.

The waste has led to leaching from discarded materials into the air, land and water as the materials breakdown and rot. The environment carries this load in the form of unnatural gas accumulations, waterborne contaminants, and degraded soils.

Much of the material currently sent to landfill or simply discarded could and should be recycled to reduce reliance on finite resources and the high economic and environmental cost associated with generating an ongoing stream of new consumables.

Handling and recovery of man-made products classified as an ‘end-of-life’ waste, has proven to be technically challenging or not economically viable. This is particularly the case when products are constructed of multiple and varied materials. These materials are, in many cases, physically bound or layered in a manner where separation is not possible or too expensive.

### SUMMARY OF THE INVENTION

According to a first aspect of the invention there is provided an aero-acoustic processing apparatus having:—
a cyclone chamber having an inlet for receiving material in the form of waste to be processed and an inlet for receiving an entraining gas; and
a rotational drive apparatus coupled to rotate an impeller which rotates within an impeller housing to draw the entraining gas and the material to be processed into the cyclone chamber and through an axial inlet system into the impeller and impeller housing and to expel the processed material through the impeller housing radially through a transverse outlet.

Processing may include comminution, separation and/or delamination of waste materials.

The waste to be processed may be in the form of end-of-life materials and/or consumable items. The waste may be formed of laminated sections. The waste may be in the form of an agglomeration of materials formed together. The waste may be in the form of any one or more of the group including solar panels, windscreens, laminated glass, safety glass, security glass, swimming pool surrounds, shower screens, LCD screens, electronic waste, batteries, gypsum board, and the like.

An enclosure may be provided for surrounding the aero acoustic processing apparatus, the enclosure being constructed to include sound attenuation panels for the reduction of noise. The sound attenuation panels may include four or more layers which together act to reduce the noise of operation of the machine when heard from outside the enclosure.

The sound attenuation panel may be a composite panel which may be constructed of four or more layers. The layers may include any one or more of the group including a plasticised film, dense Rockwool, waterproof gyprock, and a rubberised film.

The panel may be suspended a distance in the range of 10 mm to 40 mm away from an inner surface of an inner wall of the enclosure to further reduce the transmission of noise. The panel may be suspended in the region of 20 mm away from said inner surface. The panel may include a casing which may include a perforated side which, in use, faces the inner surface of the inner wall of the enclosure. The casing may be manufactured from a synthetic or metallic material, preferably being manufactured from a metallic material. The casing may have a depth in the range of 50 mm to 150 mm, preferably having a depth in the region of 100 mm deep. The panel may include a perforated sheet which, in use, faces an interior of the enclosure. The perforated sheet may be made of metal, for example, galvanised steel, stainless steel, aluminium, or the like. The perforated sheet may be 1 mm to 4 mm thick, typically 3 mm thick. The perforated sheet may have a total aperture ratio in the range of 25% to 45%, preferably having a total aperture ratio in the region of 35%. The aperture size may be in the range of 2 mm to 5 mm, preferably having a size in the region of 4 mm. The apertures may be of any suitable geometric shape. In particular, the panel may include a perforated steel sheet having a thickness in the region of 4 mm which, in use, faces an interior of the enclosure and which has a total aperture ratio of 35% with the apertures being typically 4 mm equivalent diameter.

The rotational drive apparatus may include an electrical motor.

The enclosure may include air inlets and outlets which permit air to be freely drawn into the enclosure when it is closed. Typically, the air inlets have a combined total cross-sectional area in the range of 0.5 m² to 2 m². The enclosure air inlets may be located and orientated so that the air which is drawn into the enclosure flows over coiling fins of the electric motor cooling fins thereby to keep the electric motor within an operating temperature range.

In an embodiment of the invention, the sound attenuation panels may be in the form of a composite panel. The composite panel may be constructed from four layers including:—
a plasticised film layer of 1 mm thickness;
a dense Rockwool layer of 70 mm thickness;
a waterproof gyprock layer of 20 mm thickness; and
a rubberised film layer of 4 mm thickness.

According to a second aspect of the invention, there is provided an aero-acoustic processing apparatus including an aero acoustic processing machine having a cyclone chamber having an inlet for receiving material in the form of waste to be processed and an inlet for receiving an entraining gas and a rotational drive apparatus coupled to rotate an impeller which rotates within an impeller housing to draw the entraining gas and the material to be processed into the cyclone chamber and through an axial inlet system into the impeller and impeller housing and to expel the processed material through the impeller housing radially through a transverse outlet.

Processing may include comminution, separation and/or delamination of waste materials.

The entraining gas may be drawn directly into the inlet from the environment or be pre-treated or conditioned by a conditioning means prior to being drawn in to the cyclone chamber.

The length of the cyclone chamber may be variably adjustable by slidingly displacing a trumpet portion relative to a tubular portion of the cyclone chamber at the open end thereof.

The entrained gas inlet may be an end opening of the cyclone chamber and have a flared form, preferably having an outer diameter in the range of 0.5 m to 1.5 m, preferably having an outer diameter in the region of 1 m.

The inlet into the cyclone chamber may be acutely angled in the direction of flow of the entraining gas relative the longitudinal axis of the cyclone chamber, wherein the acute angle may be in the range of 15 degrees and 18 degrees from the horizontal, preferably being in the region of 16 degrees from the horizontal (measured relative to the axis of the cyclone chamber). An inner diameter of the inlet at its opening where the material in the form of waste to be processed is added may be in the range of 300 mm and 400 mm, preferably having an inner diameter in the region of 356 mm. The inner diameter of the inlet where the waste material enters the cyclone chamber may be in the range of 325 mm to 375 mm, preferably having a diameter in the region of 336 mm.

The gas inlet and the material inlet may be made from any suitable synthetics or metallic material, preferably being manufactured from a metallic material. Further preferably, the inlets may be manufactured from steel. The inlets may have a wall thickness in the range of 5 mm to 15 mm, preferably having a wall thickness in the region of 10 mm. The inlets may be generally pipe-like or tubular in form.

The material inlet may be arranged between the 9 o'clock and 12 o'clock positions into the cyclone chamber when viewed from an axial direction.

The cyclone chamber may have an inner diameter in the range of 300 mm to 400 mm after the material inlet. The cyclone chamber may flare to a diameter in the range of 500 mm to 750 mm at the impeller housing, preferably increasing in diameter from about 336 mm at the material inlet end to about 640 mm at the impeller housing end. The flaring zone may be in the range of 1 500 mm to 2 500 mm, typically 2 000 mm.

The impeller housing may have an internal surface with an asymmetrical or eccentric configuration so that a gap between the impeller and the housing is not constant around a circumference of the impeller. The gap between the impeller and the internal surface of the impeller housing may vary over its extent.

The linear velocity of the entraining gas in the cyclone chamber at its impeller end may be in the range of 200 m/s to 260 m/s.

The transverse outlet of the impeller housing may have a surface area in the range of 0.4 m² to 1.2 m², preferably having a surface are in the region of 0.55 m². The transverse outlet may have dimensions of about 0.74 m×0.74 m.

The impeller may be a radial fan or blower impeller which may include a set of impeller vanes secured between two plates, an intake opening being provided on a central zone of one of the plates, the intake opening having a series of fixed vanes distributed around a central hub dimensioned and orientated for inducing a desired flow characteristic as the gas is drawn into the impeller.

The impeller vanes may be generally scoop-like in form and may extend substantially radially away from the central hub towards a periphery of the plates thereby to define the impeller.

The impeller may have an intake diameter in the range of 0.5 m to 0.8 m, preferably having an intake diameter in the region of 0.6096m (24″). The impeller may have an outer diameter in the range of 0.75 m to 1.1 m, preferably being in the region of 0.9144m (36″).

The impeller may be manufactured from a metallic material. Preferably, the impeller may be manufactured from steel. Further preferably, the impeller may include a nitrided steel surface for improving resistance to wear.

The impeller may be driven by a rotational drive apparatus in the form of an electric motor. The electric motor may provide a rotation speed in the range of 2 000 rpm to 5 000 rpm, preferably providing a rotational speed in the range of 3 300 rpm to 3 500 rpm. It is to be appreciated that the speed of rotation typically depends on the material being comminuted.

According to a third aspect of the invention, there is provided a process for processing waste in the form of ‘end-of-life’ materials and consumable items that are in their structure formed of laminated sections or are an agglomeration of materials formed together are exposed to processing via an aero acoustic machine that separates those parts through a range of extreme vortical forces by aero acoustic treatment.

It is to be appreciated that the inherent physical characteristics of the individual components that form a material, leads each component to react in a unique manner when impacted by the extreme forces of the aero acoustic machine, thus causing them to separate, and break the fabricated, moulded or other bonds that characterise that particular material.

The process may transform the waste into individual materials with physical characteristics similar to their original condition as separate from those attributes it may have obtained when used in combination with other component parts.

The materials may be processed by aero acoustic treatment to render recycled materials with a wide range of commercial uses including, as with glass, a return to fabrication as a newly made glass product and also for use in many commercial products to which they become a valuable input.

The materials may have a use and value when separated that exceeds their value as a waste. When separated into its constituent parts, materials may have a value that exceeds a value of the waste product as a whole.

The materials may replace products and resources that would otherwise need to be newly created or fabricated at greater expense and would therefore reduce demand for scarce and finite resources.

Recycling of materials and creating recyclables in this manner is sustainable as it saves energy and extraction costs, and reduces overall environmental impact resulting from engaging and depleting finite resources.

Through aero acoustic treatment resulting in delamination and size reduction, the rendered materials may have a greater range of uses as a recyclable and re-useable product than would otherwise be possible.

The aero acoustic delamination process employs an aero acoustic processing plant to aero acoustically delaminate and/or separate a wide range of suitable materials including but not restricted to:—
Solar Panels;
Windscreens;
Laminated Glass as may be found in Safety Glass, Security Glass, Swimming pool surrounds, Shower screens;
LCD Screens and electronic waste and batteries; and
Gypsum board.

Aero acoustic processing plant is meant to include an aero acoustic processing machine having a cyclone chamber and a rotational drive apparatus coupled to rotate an air impeller which rotates within an impeller housing to draw air and material to be processed into the cyclone chamber and through an axial inlet system into the impeller and impeller housing and expel the air and processed material through the impeller housing radially through a transverse outlet, the plant further comprising an enclosure surrounding the aero acoustic processing machine. An example thereof can be found in WO 2018/187848.

When processing such products through an aero acoustic machine, the native characteristics of multi-layered or agglomerated materials result in a distinct reaction being induced from the individual elements thereof as they react to the intense frequencies and extreme air and physical impact pressures that exist within the aero acoustic chamber. The outcome is separation of the elements from each other, each into a valuable recyclable product, and each with different physical properties from the laminated or agglomerated material from which it came.

It is to be appreciated that for the purposes of this specification, the term “comminution” is to be understood to include in its definition the meaning of the terms “separation” and “delamination”.

### BRIEF DESCRIPTION OF THE DRAWINGS

The invention will now be described by way of the following, non-limiting examples with reference to the accompanying drawings.

In the drawings:—

FIG. 1 shows an aero acoustic comminution apparatus including an aero acoustic machine;

FIG. 2 shows a cross-section of a portion of the cyclone chamber having an inlet for the material in the form of waste to be comminuted and an inlet for the entraining gas of the machine of FIG. 1;

FIG. 3 shows the impeller of the machine of FIG. 1; and

FIG. 4 shows another version of an impeller of the machine of FIG. 1.

### DETAILED DESCRIPTION OF THE INVENTION

In the example below, photovoltaic (PV) solar panels are delaminated into component parts using an aero acoustic apparatus.

PV Panels

Test 1. is to establish the degree of de-lamination of the various layers, including glass and PVB (Polyvinyl Butyral) or other interlayer material, that make up a photovoltaic panel using an aero acoustic apparatus such as that described in WO 2018/187848.

The PV Panel was cut into 5 cm×5 cm pieces and fed into an aero acoustic machine at a rate of 5 tonne per hour (tph). The components were weighed before and after processing. The outputs were then measured separately thereby indicating the percentage of separation that was achieved.

TABLE 1

| | Weight | Weight | Weight | | |
|---|---|---|---|---|---|
| | of PV | of PV | of | Residual | |
| | panel | Glass | Backing | Glass | Separated |
| | sections | Powder | Sheet | on | Glass % |
| | before | recovered | after | Backing | available |
| | processing | from pro- | pro- | Sheet | for |
| Test | 5 cm × | cessing/ | cessing/ | 5 cm × | re- |
| N^{o} | 5 cm/gm | gm | gm | 5 cm/gm | cycling |
| Test 1. | 24.44 | 20.98 | 3.46 | 0.13 | 89.03 |
| Test 2. | 24.52 | 21.57 | 2.95 | 0.20 | 87.56 |
| Test 3. | 24.36 | 21.24 | 3.12 | 0.19 | 86.37 |

TABLE 2

| | Im- | Speed: | | Ambient | Feed |
|---|---|---|---|---|---|
| | peller | RPM | Inlet | Temperature | Rate |
| Test 1. | 92 cm | 3325 | 36 cm | 22° C. | 5 tph |

Glass that makes up in the region of 88% of the total volume of outputs produced from these tests, is considered suitable for a range of commercial uses including concretes, asphalt, speciality paint finishes and reuse into new glass products. Glass powder produced from the aero acoustic machine is sharply angular making it more suitable for use in binding within mixed products than more rounded glass particles. This fine glass powder is effective as a direct replacement for sand in concrete. Sand that is suitable for concrete is scarce in many parts of the world.

The Polyvinyl Butyral (PVB) that is recovered is usable as a resin for applications that require strong binding. As a recycled raw material, it can be classified as a thermoplastic elastomer and has unique physical and mechanical properties for the plastics industry, including tenacity, flexibility, polarity, neutral colour and processability for injection, extrusion, and thermoforming.

As a new secondary raw material, recycled PVB can be used as an Elastomer, Impact modifier for homo Polypropylene, compound for use with PVC (phthalate plasticizer free), a binding agent for materials (metallic, inorganic, organic, magnetic), binding agent for textiles, hot melt, coatings, and as an adhesive.

Many countries including Australia have banned PV Panels from landfill and the panels must be recycled. At present there is no cost effective or commercially viable way to achieve the 90% plus rate of component recovery required to qualify as fully recycled. Test 1. shows that vortex processing will delaminate the PV panel and make over 88% of the residual output suitable for recycling.

Further, aero acoustic processing of PV Panels include silicon and silver metal, which are of relatively high value and which are readily available for recovery after aero acoustic treatment.

The inventor, in considering the aforementioned, proposes the following invention:

An aero acoustic device, as mentioned above, that is configured to provide conditions within the processing chamber, typically the cyclone chamber, that will maximise comminution, separation and/or delamination, and/or a range of diverse reactions, caused by the extreme forces exerted by the device on the constituent components or parts of items that may be of a form that has been moulded, pressed, fabricated or created naturally.

Many industrial scale recovery processes, now commonly used to separate and recover for re-use, the differing constituents of the item being processed, involve the use of heat to melt, burn or through pyrolysis, to reduce the various materials present to an altered, varied and separate state or to a char focussed on exposing the value of the carbon residual. The advantage of using an aero acoustic device is that the integrity of the components remains inherently intact throughout the separation process and provides higher recovery rates of usable and re-cyclable materials.

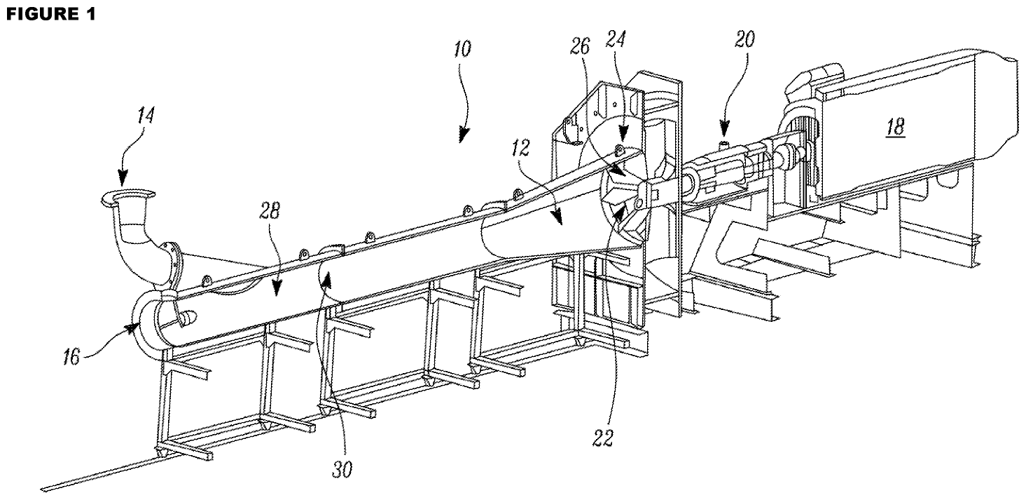

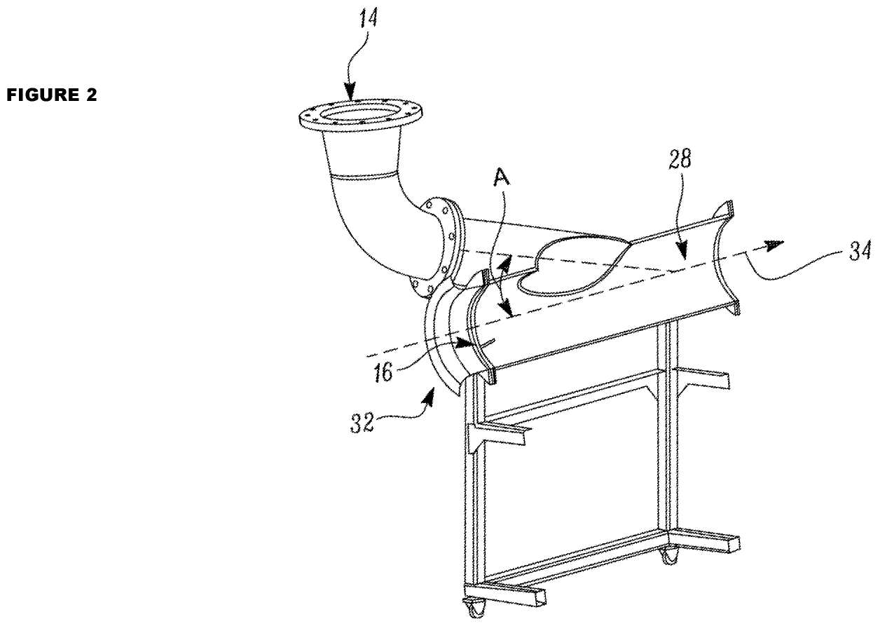

In FIGS. 1 to 3, an aero acoustic processing apparatus includes an aero acoustic processing machine 10 having a cyclone chamber 12 having an inlet 14 for the material in the form of waste (not shown) to be processed and an inlet 16 for an entraining gas in the form of air. A rotational drive apparatus in the form of an electric motor 18 is coupled to a shaft 20 to which an impeller 22 is coupled rotates the impeller 22 within an impeller housing 24 to draw the air and the waste material to be processed into the cyclone chamber 12 and through an axial inlet system 26 into the impeller 22 and impeller housing 24 and to expel the processed material through the impeller housing 24 radially through a transverse outlet.

Processing includes comminution, separation and/or delamination of waste materials.

The length of the cyclone chamber, and thus the air inlet position, is variably adjustable by slidingly displacing a trumpet portion 28 relative to a tubular portion 30 of the cyclone chamber 12 at the open end thereof. The air inlet 16 has a diameter of 1 m at the trumpet portion 28 edge 32.

Flat tangential angle A of the inlet 14 allows waste material to enter the intense vortex airflow in the cyclone chamber 12 with minimum disruption to a vortex that exists in the centre of the cyclone chamber 12. The inlet 14 can be set to an angle A of 17 degrees to the centre line 34 to allow the particles of the waste material to be processed to accelerate to over 200 m/s while still in the inlet 14 thereby causing minimum effect on the air speed or the vortex forces in the cyclone chamber 12.

The waste material inlet 14 into the cyclone chamber 12 is angled at 17 degrees in the direction of flow of the entraining air relative the longitudinal axis centre line 34 of the cyclone chamber 12 and at between the 9 o'clock and 12 o'clock position into the cyclone chamber 12 when viewed from an axial direction. The inner diameter of inlet 14 at its opening where the waste material to be comminuted is added is typically 356 mm. The inner diameter of inlet where the material enters the cyclone chamber 12 is typically 336 mm.

The air inlet 16 and the waste material inlet 14 are made of steel having a wall thickness of typically 10 mm. The inlets 14 and 16 are typically generally pipe-like in form.

The cyclone chamber 12 has an inner diameter of 336 mm at the waste material inlet 14 end and increases to 640 mm at the impeller housing 24 end i.e., it flares towards the impeller housing 24.

The impeller housing 24 has an internal surface (not shown) with an asymmetrical configuration so that a gap between the impeller 22 and the housing 24 is not constant around the circumference of the impeller 22. Thus, in use, the gap between the impeller 22 and the internal surface of the impeller housing 24 varies over its extent.

The linear velocity of the air flowing through the cyclone chamber 12 at its impeller 22 end is typically in the range of 230 m/s to 260 m/s.

The transverse outlet of the impeller housing 24 is typically about of 0.55 m². The transverse outlet typically has dimensions of about 0.74 m×0.74 m.

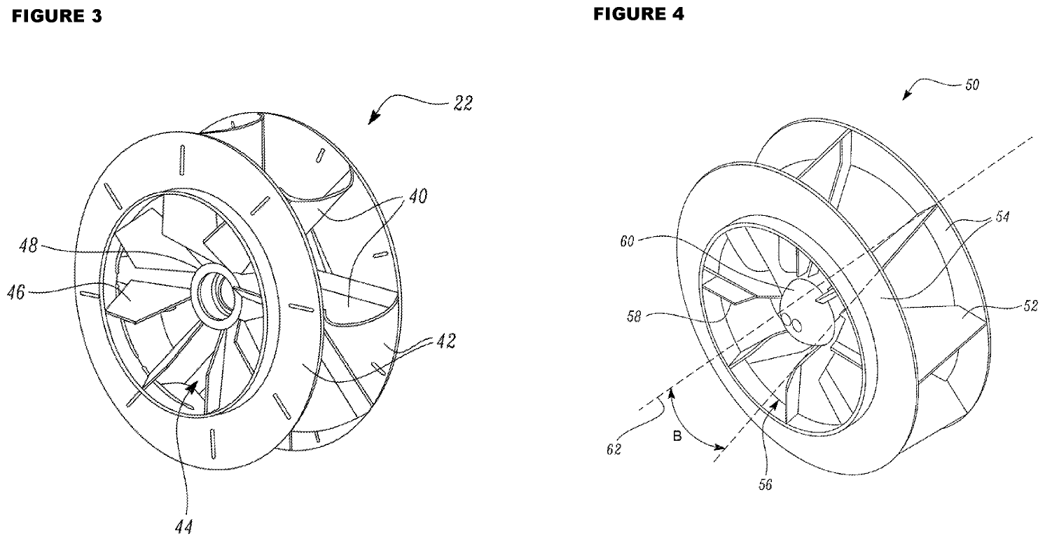

The impeller 22 shown in FIG. 3, is a radial fan impeller having a set of impeller vanes 40 secured between two plates 42, an intake opening 44 being provided on a central zone of one of the plates 42, the intake opening 44 having a series of fixed vanes 46 distributed around a central hub 48 dimensioned and orientated for inducing a desired flow characteristic as the gas is drawn into the impeller 22. The impeller vanes 40 in this embodiment are scoop-like and extend radially away from the hub 48 towards a periphery of the plates 42 thereby to define the impeller 22.

The impeller 22 has an intake diameter in the range of 0.5 m to 0.8 m, typically having an intake diameter in the region of 0.6096m (24″). The impeller 22 has an outer diameter in the range of 0.75 m to 1.1 m, typically being in the region of 0.9144 m (36″).

The impeller 22 of this embodiment is manufactured from steel having a nitrided steel surface to improve resistance to wear.

The impeller 22 has a rotation speed of from 3 300 rpm to 3 500 rpm but the speed of rotation typically depends on the material being comminuted.

The embodiment of impeller 50 shown in FIG. 4, is a radial fan impeller having a set of impeller vanes 52 secured between two plates 54, an intake opening 56 being provided on a central zone of one of the plates 54, the intake opening 56 having a series of fixed vanes 58 distributed around a central hub 60 dimensioned and orientated for inducing a desired flow characteristic as the gas is drawn into the impeller. The vanes 52 in this embodiment have a flat profile and are angled at an angle B of up to 15 degrees off the centre line 62 of the shaft 20 to promote a more efficient and dispersed particle flow through the impeller 50. This also reduces the stress and pressure on the metal vanes 52, and the wear on the surface of the vanes 52.

### Advantages

Aero acoustic processing of waste materials is less likely to produce compounds from heat or chemical changes and separation, which in themselves create an environmental issue as their disposal is often a larger and more complex and compromising issue than managing the disposal of the original item, and as such reduces recovery environmental and commercial efficiencies.

The use of an aero acoustic device to process waste materials substantially reduces the cost associated with separation and re-cycling. The industry accepted costs of specialised equipment to produce heat and to manage hot, sometimes molten materials, liquids and to control exhaust gases are negated by using an aero acoustic device. Although some value may be recovered, the residual waste is usually non-compliant and becomes part of a highly regulated and expensive waste disposal exercise.

The materials may also be recycled using a grinding process. The use of basic grinding equipment to delaminate by its nature will create a single residual agglomeration of all materials that requires a further raft of separation processes to resolve the extraction of viable reusable products.

An aero acoustic device has been used to produce extreme forces including high speed air at above 700 kph with associated vortices and a wide range of intense sonic and harmonic frequencies (1998 patent describes this best WO1998035756A1). As the impeller that is used to generate the air flow in the device is the only one moving part, maintenance can be significantly reduced. Separation and resource recovery is at present a labour and capital intense business, challenging in most circumstances and beyond the financial and technical reach of many countries.

High throughput rates for the given energy required makes the aero acoustic device extremely efficient with relatively little manpower required to operate, and a simple layout with a pipe, fan housing, impeller and drive motor forming the basis of the devices fabricated parts. Throughput of 10 to 25 tonne per hour of materials such as windscreen glass, solar panels, and other laminates use less than 25 kwh/tonne.

The energy efficiency makes the devices environmentally efficient placing less pressure on resources when in operation, while providing a variety of recovery and re-cycling options for an assortment of waste materials.

The device is practical and commercial as its size and configuration is suited to it being built inside a 40 ft high cube container that has the necessary sound attenuation fitted to the walls. In this form it is highly mobile being able to move to various locations with ease. This characteristic makes it both functional and sensible for use in a wide range of commercial scenarios. Many items for which the delaminating attributes of the device are suited have no genuine commercial alternatives with governments throughout the world spending 10's of millions to discover a solution to the high rates of dumping to landfill that exists with solar panels, plasterboard and other laminates.

It is, of course, to be appreciated that the aero acoustic comminution apparatus and processes employed thereby in accordance with the invention are not limited to the precise constructional and functional details as hereinbefore described with reference to the accompanying drawings and which may be varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

1. An aero acoustic processing apparatus which includes:
an aero acoustic processing machine having:
a cyclone chamber having an inlet for material in the form of waste to be processed and an inlet for receiving an entraining gas; and
a rotational drive apparatus coupled to rotate an impeller which rotates within an impeller housing to draw the entraining gas and the material to be processed into the cyclone chamber and through an axial inlet system into the impeller and impeller housing and to expel the processed material through the impeller housing radially through a transverse outlet, wherein processing includes comminution of waste materials in the form of end-of-life materials.

2. (canceled)

3. (canceled)

4. The aero acoustic processing apparatus as claimed in claim 1 wherein the waste to be processed is in the form of consumable items.

5. The aero acoustic processing apparatus as claimed in claim 1 wherein the waste is formed of laminated sections.

6. The aero acoustic processing apparatus as claimed in any one or more of the preceding claims wherein the waste is in the form of an agglomeration of materials formed together.

7. The aero acoustic processing apparatus as claimed in claim 1 wherein the aero acoustic processing machine is configured to comminute, separate or delaminate the waste into its constituent parts through a range of extreme vortical forces by aero acoustic treatment.

8. The aero acoustic processing apparatus as claimed in claim 1 wherein the waste is in the form of solar panels.

9. The aero acoustic processing apparatus as claimed in claim 1 wherein the waste is in the form of windscreens.

10. The aero acoustic processing apparatus as claimed in claim 1 wherein the waste is in the form of laminated glass.

11. The aero acoustic processing apparatus as claimed in claim 8 wherein the laminated glass includes any one of the group including safety glass, security glass, swimming pool surrounds, shower screens, and the like.

12. The aero acoustic processing apparatus as claimed in claim 1 wherein the waste is in the form of LCD screens.

13. The aero acoustic processing apparatus as claimed in claim 1 wherein the waste is in the form of electronic waste.

14. The aero acoustic processing apparatus as claimed in claim 1 wherein the waste is in the form of a battery.

15. The aero acoustic processing apparatus as claimed in claim 1 wherein the waste is in the form of gypsum board.

16. The aero acoustic processing apparatus as claimed in claim 1 wherein the aero acoustic machine is configured to provide conditions within the cyclone chamber that maximise comminution, separation or delamination of the waste.

17. The aero acoustic processing apparatus as claimed in claim 1 wherein the aero acoustic machine is configured to provide conditions within the cyclone chamber that maximise a range of diverse reactions caused by the extreme forces exerted on the constituent parts of the waste.

18. (canceled)

19. (canceled)

20. (canceled)

21. A process for processing waste, which waste is formed of laminated sections or is an agglomeration of materials formed together are exposed to processing via an aero acoustic machine that separates those parts through a range of extreme vortical forces by aero acoustic treatment, wherein the process employs an aero acoustic processing plat to aero acoustically comminute, delaminate or separate a range of waste materials, and wherein the range of waste materials include any one or more of the group including solar panels, windscreens laminated glass, safety glass, security glass, swimming pool surrounds, shower screens, LCD screens, electronic waste, batteries, and gypsum board.

22. (canceled)

23. (canceled)

24. A process as claimed in claim 21 wherein the processing plant incudes an aero acoustic processing machine having a cyclone chamber and a rotational drive apparatus coupled to rotate an impeller housing to draw air and material to be processed into the cyclone chamber and through an axial inlet system into the impeller and impeller housing and expel the air and processed material through the impeller housing radially through a transverse outlet, the plant further comprising an enclosure surrounding the aero acoustic processing machine

25. (canceled)

26. (canceled)
